(19) United States
(12) Patent Application Publication
(10) Pub. No.: US 2015/0207593 A1
(43) Pub. Date: Jul. 23, 2015

(54) METHOD AND APPARATUS OF RETRANSMISSION BASED ON SOFT COMBINING IN CONTENTION BASED ACCESS SYSTEM

(71) Applicant: ELECTRONICS AND TELECOMMUNICATIONS RESEARCH INSTITUTE, Daejeon (KR)

(72) Inventors: Kyung Yul CHEON, Daejeon (KR); Eun Sook JIN, Daejeon (KR); Chang Joo KIM, Daejeon (KR)

(21) Appl. No.: 14/589,328

(22) Filed: Jan. 5, 2015

(30) Foreign Application Priority Data
Jan. 20, 2014 (KR) 10-2014-0006861

(51) Int. Cl. H04L 1/16; H04L 27/26; H04L 1/18; H04W 74/08

(52) U.S. Cl. CPC H04L 1/1657; H04W 74/0825; H04L 27/2627; H04L 1/1812; H04L 1/1809

(57) ABSTRACT

A method and apparatus of an effective and reliable retransmission based on soft combining when using orthogonal frequency division multiplexing (OFDM) modulation technique in a contention based access system. The method includes receiving a data signal from a transmission node, performing soft combining the valid section part of the data signal which have been previously received and the data signal currently received, determining a collision section of the data signal which is currently received, and saving a valid section part except the collision section of the data signal which is currently received in a buffer. In the contention based access system that uses OFDM modulation technique, in case that data signal reception failure occurs due to a transmission collision, the valid part of the received data signal may be detected and effectively applied to the soft combining, and consequently, the reception probability of data signal can be increased.

Priority to Korean patent application number 10-2014-0006861 filed on Jan. 20, 2014, the entire disclosure of which is incorporated by reference herein, is claimed.

### BACKGROUND OF THE INVENTION

1. Field of the Invention

The present invention relates to wireless communications and more particularly, to a method and apparatus of an effective and reliable retransmission based on soft combining when using orthogonal frequency division multiplexing (OFDM) modulation technique in a contention based access system.

2. Discussion of the Related Art

Presently, in mobile communication technology such as 3rd generation partnership project (3GPP) long term evolution (LTE), a hybrid automatic repeat request (HARQ) technique has been widely used to improve effectiveness in data transmission and reliability. A receiver using the HARQ, basically, tries to correct errors for the received data signals, and determines whether to retransmit data using error detection codes. Error detection codes may use a cyclic redundancy check (CRC). If an error in data signals is not detected by the CRC detection process, the receiver determines that decoding of the data signals is succeeded. In this case, the receiver transmits an acknowledgement (ACK) signal to a transmitter. If an error in the data signals is detected through the CRC detection process, the receiver determines that the decoding of the data signals is failed. In this case, the receiver forwards a non-acknowledgement (NACK) signal to the transmitter. When the NACK signal is received, the transmitter may retransmit the data signal.

The HARQ technique may use soft combining. The soft combining is a technique that increases signal-to-noise ratio (SNR) and data receiving efficiency by combining the data received previously and the data to be currently received data at a receiver in a retransmission procedure due to the transmission failure in order to guarantee the effectiveness of the retransmission. The soft combining technique may have good performance in such a case that a base station allocates radio resources to user equipments without being overlapped as in LTE or Wibro based communication. However, in case of carrier sensing multiple access/collision avoidance (CSMA/CA), which is a contention based access technique such as a wireless LAN being used, a contention or a collision may occur in a packet transmission. In this case, the data received by a receiver undergoes serious interference due to the collision signal, and consequently, the effect of soft combining is seriously degraded. That is, if a collision occurs when a transmitter transmits data signals, as the data signal include a big interference signal, the SNR rather becomes worse in case that a receiver uses the data signals in soft combining, which causes a problem that data reception efficiency is further degraded.

Accordingly, in order to use the soft combining effectively in the contention based access system such as a wireless LAN, the technique of identifying the data signal in which a transmission collision occurs and selectively using it.

### SUMMARY OF THE INVENTION

An object of the present invention to solve the problem of described above is to provide a method and apparatus of retransmission based on soft combining in a contention based access system.

Another object of the present invention to solve the problem of described above is to provide a method and apparatus of soft combining which is effective in retransmitting data in a OFDM based contention based access system.

Still another object of the present invention to solve the problem of described above is to provide a method and apparatus of identifying the data signal in which a transmission collision occurs and selectively using it.

Another object of the present invention to solve the problem of described above is to select a valid part in the data signal and to use it in soft combining if a collision occurs in transmitting data signal.

Still another object of the present invention to solve the problem of described above is to detect a section in which collision occurs in a received data signal, and to perform soft combining by selecting the valid part in the data signal.

According to an aspect of the present invention, a method of soft combining in a contention based access system using orthogonal frequency division multiplexing (OFDM) modulation technique is provided. The method includes receiving a data signal from a transmission node, determining a collision section of the received data signal, saving a valid section part except the collision section of the data signals, receiving again the data signal from the transmission node, and performing soft combining the valid section part of the data signal saved in the buffer and the data signal received again.

According to an aspect of the present invention, a reception node based on a contention based access system that uses an orthogonal frequency division multiplexing (OFDM) modulation technique is provided. The reception node includes a receiving unit configured to receive a data signal from a transmission node, a collision detector configured to determine a collision section of the received data signal, and a buffer configured to save a valid section part except the collision section of the data signal.

According to yet another aspect of the present invention, a method of soft combining performed by a reception node in a contention based access system using an orthogonal frequency division multiplexing (OFDM) modulation technique is provided. The method includes receiving a data signal from a transmission node, performing soft combining the valid section part of the data signal which have been previously received and the data signal currently received, determining a collision section of the data signal which are currently received, and saving a valid section part except the collision section of the data signal which are currently received in a buffer.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 illustrates an example of a receiver diagram in a contention based access system according to the present invention.

FIG. 2 illustrates an example of a physical layer OFDM resource map to which the present invention applies.

FIG. 3 illustrates an example of a flow chart of soft combining in a contention based access system according to the present invention.

FIG. 4 illustrates another example of the flow chart of soft combining in a contention based access system according to the present invention.

FIG. 5 is an example of a flow chart of soft combining in the contention based access system according to the present invention.

### DETAILED DESCRIPTION OF THE INVENTION

The preferred embodiment of the present invention now will be described in detail by reference to the accompanying exemplary drawings in this specification. In attaching reference numerals to elements in each drawing, it should be understood that the same reference numeral is used for the same element even if the element is shown in different drawings. In addition, in case that the detailed description for the related known elements and functions is determined to obscure the inventive concept in this specification, the redundant description for the same element will be omitted.

The present invention suggests a soft combining method for effectively performing retransmission such as ARQ or HARQ in a contention based access system using OFDM modulation technique such as institute of electrical and electronics engineers (IEEE) 802.11. According to the present invention, SNR and reception efficiency can be improved by detecting a section in which a collision occurs in data (or packet) transmitted in a contention based access system, and by performing the soft combining with a valid part selecting in the data (or packet) that have not affected by the collision.

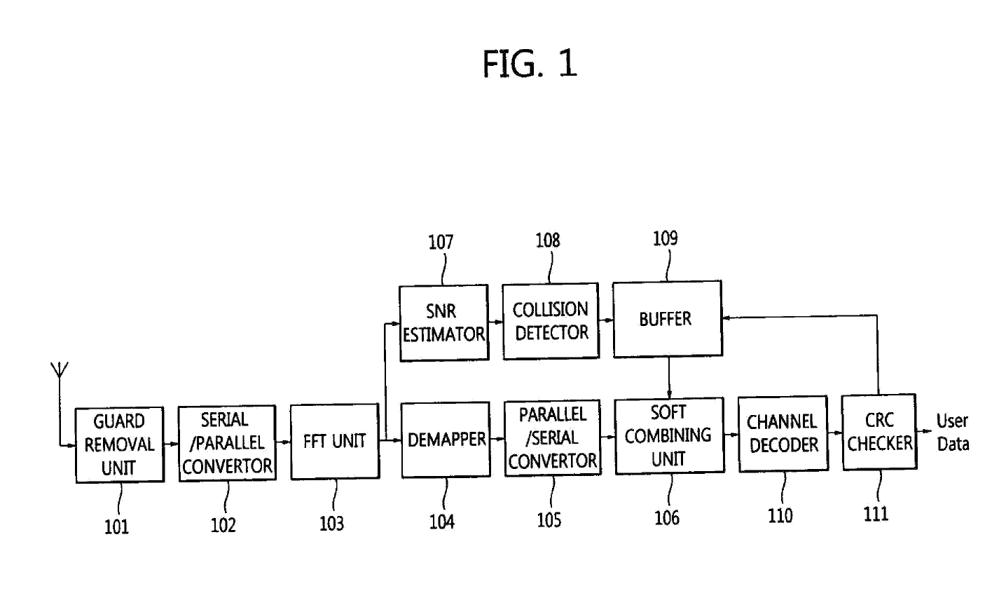

FIG. 1 illustrates an example of a receiver diagram in a contention based access system according to the present invention.

Referring to FIG. 1, the receiver according to the present invention includes a fast Fourier transform (FFT) unit 103, a soft combining unit 106, a SNR estimator 107, a collision detector 108 and a buffer 109.

When the receiver receives data signal through a receiving unit, the receiver performs the FFT algorithm through the FFT unit 103, and later, estimates the SNR of the OFDM symbols which are included in the data signal through the SNR estimator 107.

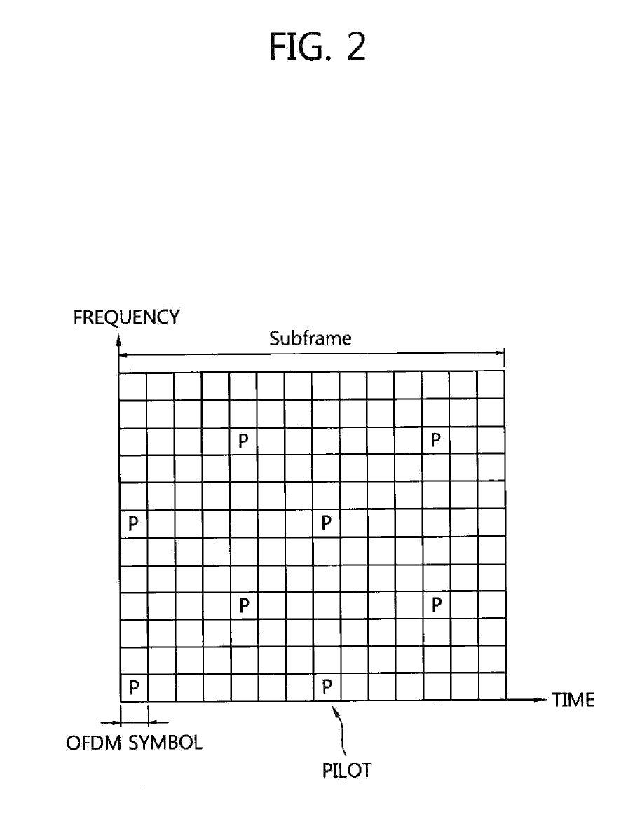

FIG. 2 illustrates an example of a physical layer OFDM resource map to which the present invention applies.

Referring to FIG. 2, a subframe includes multiple OFDM symbols in a time domain. A subframe includes one or more subcarriers in a frequency domain. A subframe includes at least one pilot in a designated time and frequency domain.

The SNR estimator 107 may detect the pilots among the OFDM symbols and the SNR of the pilots, thereby estimate the SNR of the OFDM symbols.

Referring to FIG. 1 again, the collision detector 108 may determine a collision section and a valid section based on the SNR of the estimated OFDM symbols.

As an example, the collision detector 108 may determine a collision section and a valid section based on determining whether the SNR of the pilots has a predetermined value or more. As another example, the collision detector 108 may determine a collision section and a valid section based on determining whether there is a section where the SNR of the pilots is abruptly degraded. That is, the collision detector 108 may determine such a case to be a collision section that the variation of which the SNR of the pilots in the direction to be degraded is a predetermined reference value or more in a time domain and the remaining section to be a valid section. This is because the channel state is represented almost similarly and SNR is not significantly changed in the short time domain when data signal for packet) is transmitted in a common radio channel. Accordingly, when a transmission collision occurs, the SNR is abruptly degraded from the time of the collision occurrence, and so it is available to determine whether a collision occurs or where a collision section is based on the SNR value itself of the pilot or the development of changes in the SNR value of the pilot. Hereinafter, the process of selecting a valid part that is not influenced by the collision is defined as a collision detection function. Through the collision detection function, the valid section except the section where SNR is below a proper value or the section where the SNR is abruptly decreased can be selected.

The buffer 109 saves a valid section of data signal except the collision section, and the soft combining unit 106 utilizes the valid section of the data signal in soft combining.

Meanwhile, the receiver according to the present invention further includes a guard removal unit 101, a serial/parallel (S/P) convertor 102, a demapper 104, a parallel/serial (PIS) convertor 105, a channel decoder 110 and a CRC checker 111. The guard removal unit 101 removes a guard interval from the received data signal, and forwards the data signal of which a guard interval is removed to the serial/parallel convertor 102. Since the transmitter based on the OFDM transmits data in such a manner that a guard interval is inserted after performing inverse fast Fourier transform (IFFT), the guard removal unit 101 of the receiver removes the guard interval. For example, the guard interval may be a cyclic prefix (CP).

The serial/parallel convertor 102 converts the data signal of which a guard interval is removed from serial to parallel and forwards it to the FFT unit 103, and the FFT unit 103 performs the EFT algorithm on the parallel data signal, and generates parallel signals in frequency domain. The parallel signals in frequency domain undergo a demapping process through the demapper 104, and are forwarded to the parallel/serial convertor 105. The parallel/serial convertor 105 coverts the parallel signals in frequency domain as the sequences of modulated data symbols.

The channel decoder 110 performs decoding and restores the original data signal, and the CRC checker 111 performs CRC check and determines whether the decoding of the data signal is successful.

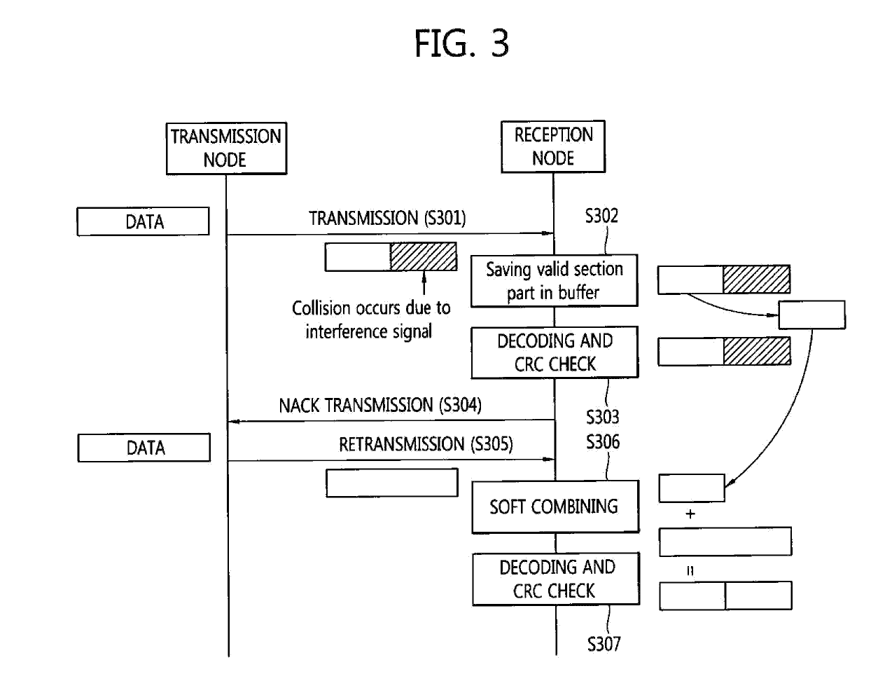

FIG. 3 illustrates an example of a flow chart of soft combining in a contention based access system according to the present invention. The transmission node in FIG. 3 may be a transmitter, and the reception node may be a receiver.

Referring to FIG. 3, the transmission node transmits data signal(s) (step, S301). Since the communication between the transmission node and the reception node is based on the contention based access system, a collision in the data signal may occur by signals transmitted from a different transmission node. That is, while a transmission node transmits a data signal in the contention based access system, another transmission node in transmission or interference region performs a transmission as well, the transmission signals of the two transmission nodes are duplicated, and consequently, a collision section may occur. In this case, the reception node receives the data signal that have a significant noise.

The reception node detects a valid section of the received data signal, and saves the valid section in the buffer (step, S302). The reception node may select a part that is not influenced by the interference due to the transmission collision, that is, a valid section part, and save it in the buffer. The reception node may detect pilots among the OFDM symbols of the received data signal, and detect the SNR of the pilots, thereby estimate the SNR of the data signal. As an example, the reception node may determine a collision section and a valid section based on determining whether the SNR of the pilots is over a predetermined value. As another example, the reception node may determine a collision section and a valid section based on determining whether there is a section where the SNR of the pilots is abruptly degraded in the time domain.

The reception node performs decoding and a CRC check of the received data signal (step, S303).

In case of determining that decoding the data signals is failed through the CRC check, the reception node transmits a non-acknowledgement (NACK) signal to the transmission node (step, S304).

When the transmission node receives the NACK signal, the reception node recognizes it as a reception failure of the data signal, and retransmits the data signal (step, S305).

The reception node that receives the retransmitted data signal performs soft combining the retransmitted data signal and the valid section part saved in step, S302 (step, S306), and then performs decoding and CRC check (step, S307). Through the filtering process for the transmission collision noise, the influence due to the transmission collision in soft combining may be minimized, and the transmission efficiency may be increased by acquiring high SNR of data signals.

Meanwhile, although it is not depicted in FIG. 3, the receiver may determine a valid section of the retransmitted data signal for soft combining with subsequent retransmissions after step, S305, and also save the valid section part in the buffer.

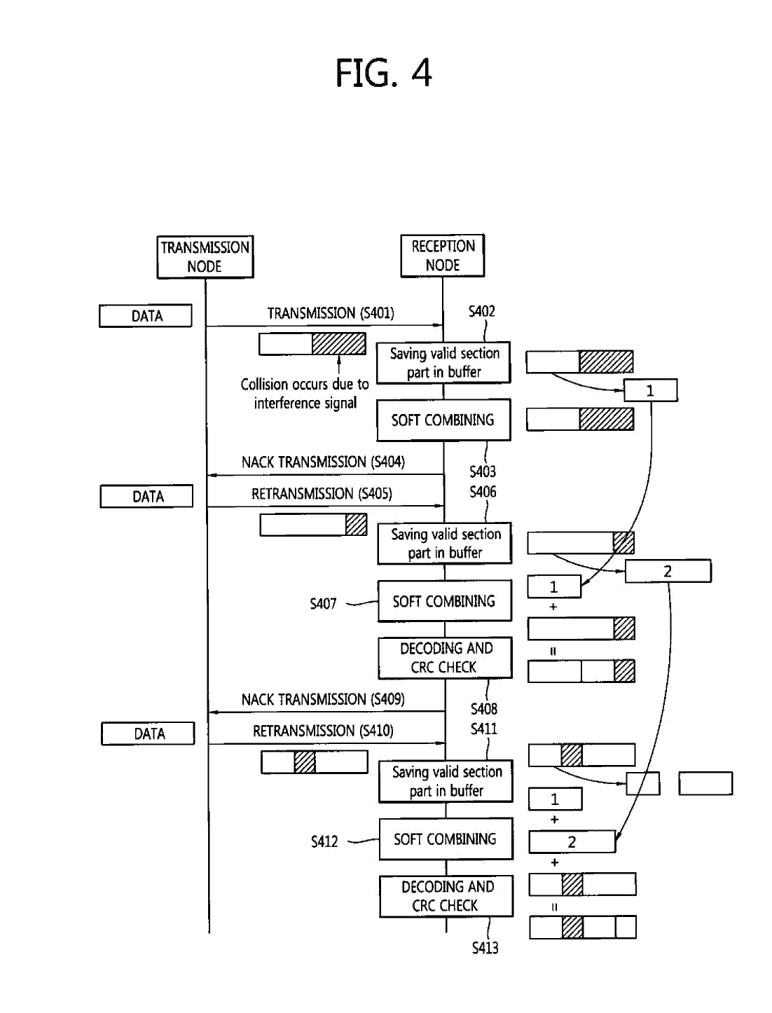

That is, if the result of the CRC check in step, S307 is also NACK, the reception node transmits the NACK signal to the transmission node again, and the transmission node performs a second retransmission of the data signal. In this case, the reception node may perform soft combining the data signal which is secondly retransmitted with the valid section part of the data signal which is initially transmitted in step, S301 and the valid section part of the data signal which is firstly retransmitted in step, S305, and then perform decoding and a CRC check. In such multiple retransmissions, the soft combining operation will be described in detail by exemplifying the following FIG. 4.

FIG. 4 illustrates another example of the flow chart of soft combining in a contention based access system according to the present invention. FIG. 4 represents the case that retransmissions occur twice.

Referring to FIG. 4, since steps, S401, S402, S403, S404 and S405 are identical to the processes of steps, S301, S302, S303, S304 and S305, the detailed description will be omitted.

In step, S405, the reception node that receives data signals that is firstly retransmitted detects a valid section of the firstly retransmitted data signal(s), and saves the valid section part in the buffer (step, S406).

The reception node performs soft combining the data signal firstly retransmitted and a valid section part of the data signals which is saved in step, S402, (step, S407), and performs decoding and a CRC check (step, S408).

If the result of the CRC check in step, S407 is also NACK, the reception node transmits the NACK signal to the transmission node again (step, S409).

If the transmission node receives the NACK signal, the transmission node determines that the reception node is still in failure of receiving the data signal, and retransmits the data signals secondly (step, S410).

The reception node receiving the data signal which are secondly retransmitted in step, S410, detects the valid section of the data signal secondly retransmitted, and saves the valid section part in the buffer (step, S411). The reception node performs soft combining the data signals secondly retransmitted and the valid section part of initially transmitted data signal which is saved in step, S402, and the valid section part of firstly retransmitted data signal which is saved in step, S406 (step, S412), and then performs decoding and the CRC check (step, S413).

Meanwhile, referring to FIG. 3 and FIG. 4, the reception node directly saves the valid section part and performs the CRC check when the reception node receives the data signals though, this is only an example, rather the reception node may perform the CRC check first and determine whether decoding of the data signal is successful, and save the valid section part of the data signal only the case that decoding is failed.

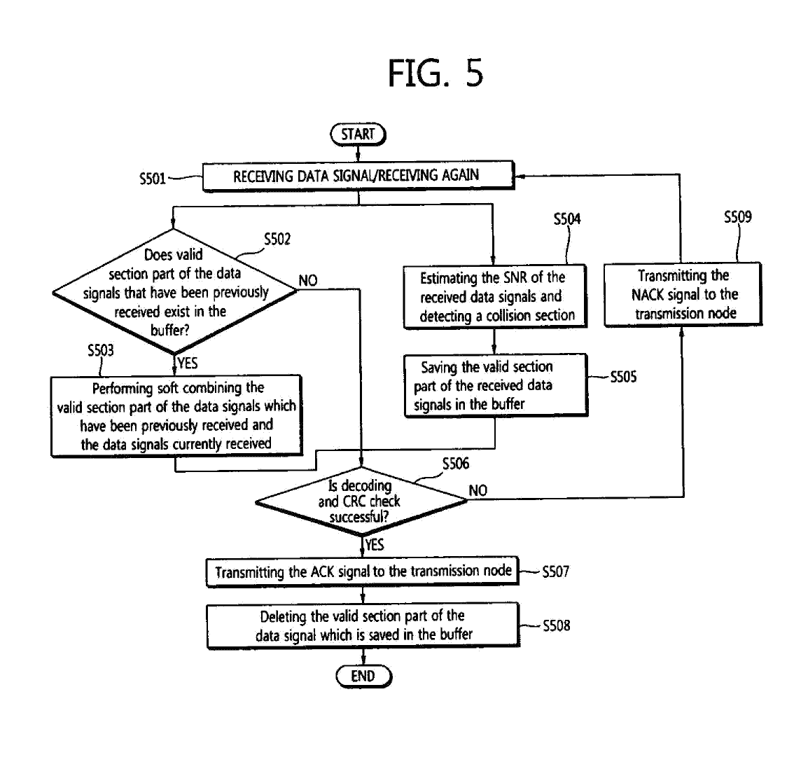

FIG. 5 is an example of a flow chart of soft combining in the contention based access system according to the present invention.

Referring to FIG. 5, the reception node receives or receives again the data signal(s) in a reception waiting state (step, S501).

The reception node determines whether a valid section part of the data signal previously received exists in the buffer (step, S502).

If a valid section part of the data signals that have been previously received in the buffer in step, S502 exists, the reception node performs soft combining the data signal that have been previously received and the data signal that is currently to be received (step, S503).

If a valid section part of the data signals that have been previously received in the buffer in step, S502 does not exist, just move to step, S506.

Meanwhile, the reception node estimates the SNR of the received data signal and detects a collision section (step, S504). In this case, the reception node may detect the pilots among the OFDM symbols of the received data signal and also detect the SNR of the pilots, thereby estimate the SNR of the data signal, as described above. As an example, the reception node may determine a collision section and a valid section based on determining whether the SNR of the pilots is over a predetermined reference value. As another example, the reception node may determine whether there is a section where the SNR of the pilots is abruptly degraded, that is, in a time domain, may determine a collision section and a valid section based on determining whether the variation of which the SNR of the pilots is over a predetermined reference value.

The reception node saves the valid section part of the received data signal in the buffer (step, S505). The reception node performs decoding of the data signal which is soft combined the soft combining and the CRC check (step, S506).

If an error is not detected as a result of the CRC check in step, S506, the reception node transmits the ACK signal to the transmission node (step, S507).

Later, the reception node deletes the valid section part of the data signal which is saved in the buffer (step, S508).

If an error is detected as a result of the CRC check in step, 5506, the reception node transmits the NACK signal to the transmission node (step, S509). Later, the reception node returns to step, S501 and waits the retransmission of the data signal in reception waiting state.

According to the present invention, in the contention based access system that uses OFDM modulation technique, in case that data signal, reception failure occurs due to a transmission collision, the valid part of the received data signal(s) may be detected and effectively applied to the soft combining, and consequently, the reception probability of data signal can be increased.

So far, the present invention has been described by reference to the drawings and the embodiments as an example, and it should be understood by those skilled >in the art, however, that the present invention can be modified or changed in various ways without departing from the technical principles and scope. Accordingly, the embodiment disclosed in the present invention is not intended to limit the scope of the inventive concept of the present invention, but to describe, and the scope of the inventive concept of the present invention is not limited to the embodiment. The scope of the present invention should be interpreted by the claims below, and it should be interpreted that all inventive concept within the equivalent scope is included in the scope of the present invention.

What is claimed is:

1. A method of soft combining in a contention based access system using orthogonal frequency division multiplexing (OFDM) modulation technique, comprising:
receiving a data signal from a transmission node;
determining a collision section of the received data signal;
saving a valid section part except the collision section of the data signal;
receiving again the data signal from the transmission node; and
performing soft combining the valid section part of the data signal saved in the buffer and the data signal received again.

2. The method of claim 1, wherein the collision section is determined based on signal to noise ratio (SNR) of the data signal.

3. The method of claim 2, wherein the SNR of the data signal is estimated by detecting pilots among OFDM symbols of the received data signal, and detecting the SNR of the pilots.

4. The method of claim 3, wherein the collision section is determined based on determining whether the SNR of the pilots is a predetermined reference value or more.

5. The method of claim 3, wherein the collision section is determined based on determining whether the variation of the SNR of the pilots is a predetermined reference value or more in a time domain.

6. A reception node based on a contention based access system that uses an orthogonal frequency division multiplexing (OFDM) modulation technique, comprising:
a receiving unit configured to receive a data signal from a transmission node;
a collision detector configured to determine a collision section of the received data signal; and
a buffer configured to save a valid section part except the collision section of the data signal.

7. The reception node of claim 6, further comprising a soft combining unit configured to perform soft combining based on the valid section part of the data signal saved in the buffer.

8. The reception node of claim 7, wherein the receiving unit receives the data signal again from the transmission node, and
wherein the soft combining unit performs soft combining the valid section part of the data signal saved in the buffer and the data signal received again.

9. The reception node of claim 7, further comprising an SNR estimator configured to estimate signal to noise ratio (SNR) of the data signal,
wherein the collision estimator determines the collision section based on the SNR of the data signal.

10. The reception node of claim 9, wherein the SNR estimator estimates SNR of the data signal by detecting pilots among OFDM symbols of the received data signal, and detecting the SNR of the pilots.

11. The reception node of claim 10, wherein the collision detector determines the collision section based on determining whether the SNR of the pilots is a predetermined reference value or more.

12. The reception node of claim 10, wherein the collision detector determines the collision section based on determining whether the variation of the SNR of the pilots is a predetermined reference value or more in a time domain.

13. The reception node of claim 9, further comprising:
a decoder configured to decode the data signal which is soft combined; and
a CRC checker configured to perform a cyclic redundancy check (CRC) check for the decoded data signal, and determine whether the decoding of the data signal is successful.

14. A method of soft combining performed by a reception node in a contention based access system using an orthogonal frequency division multiplexing (OFDM) modulation technique, comprising:
receiving a data signal from a transmission node;
performing soft combining the valid section part of the data signal which have been previously received and the data signal currently received;
determining a collision section of the data signal which is currently received; and
saving a valid section part except the collision section of the data signal which is currently received in a buffer.

15. The method of claim 14, further comprising:
decoding the data signal which is soft combined; and
performing a cyclic redundancy check (CRC) check for the decoded data signal, and determining whether the decoding of the data signal is successful

16. The method of claim 15, further comprising:
if an error is not detected as a result of the CRC check, determining that decoding of the data signal is successful, and transmitting an acknowledgement (ACK) signal to the transmission node; and
deleting the valid section part of the data signal saved in the buffer.

17. The method of claim 16, further comprising:
if an error is detected as a result of the CRC check, determining that decoding of the data signal is failure, and transmitting a non-acknowledgement (NACK) signal to the transmission node; and
receiving again the data signal.

18. The method of claim 17, further comprising:
estimating signal to noise ratio (SNR) of the data signal which is currently received,
wherein the collision section is determined based on the SNR of the data signal.

19. The method of claim 18, wherein the collision section is determined by detecting pilots among OFDM symbols of the received data signal, and determined based on estimating whether the SNR of the pilots is a predetermined reference value or more.

20. The method of claim 18, wherein the collision section is determined by detecting pilots among OFDM symbols of the received data signal, and determined based on estimating whether the variation of the SNR of the pilots is a predetermined reference value or more in a time domain.
